(19) United States
(12) Patent Application Publication
(10) Pub. No.: US 2004/0098742 A1
(43) Pub. Date: May 20, 2004

(54) Apparatus and method of producing preview files

(76) Inventors: Min Lun Hsieh, Taipei (TW); Chin-Chou Chang, Taipei (TW)

Correspondence Address: BIRCH STEWART KOLASCH & BIRCH, PO BOX 747, FALLS CHURCH, VA, 22040-0747, US

(21) Appl. No.: 10/702,773

(22) Filed: Nov. 7, 2003

(30) Foreign Application Priority Data
Nov. 18, 2002 (TW) 091133596

(51) Int. Cl. G06F 3/00

(52) U.S. Cl. 725/37

(57) ABSTRACT

An apparatus of producing preview files for previewing data frames. The inventive apparatus includes a playback engine, a rendering engine, and a drawing engine. The playback engine evaluates source frame data to obtain source frame grades, receives preview grade information, and sends a preview requirement according to the preview grade information. The rendering engine receives the preview requirement, obtains frame data from files according to the preview requirement and the source frame grades, and transfers the frame data into preview files. The drawing engine receives the preview frame files and outputs preview frames of the preview files.

### BACKGROUND OF THE INVENTION

1. Field of the Invention

The present invention relates to a multimedia data preview technology, and in particular to an apparatus and method of producing preview files for previewing data frames.

2. Description of the Related Art

Multimedia playback includes video and audio data output, thus one critical requirement of multimedia playback is output smoothness. The present multimedia playback technology usually utilizes data frame preview to achieve smooth multimedia playback. Generally speaking, when data frame preview execution is required, the multimedia system must transfer all frames into preview files. In other words, the general multimedia playback system does not provide a tool for selection of only desired frames.

As an example, multimedia preview information is sent in a multimedia playback system. A playback engine receives the information and sends a preview requirement to a rendering engine according to the received information. The rendering engine receives the preview requirement and obtains and transfers source data frames into preview files from source files. Subsequently, the rendering engine sends the transferred preview files to a drawing engine for output. The drawing engine receives the preview files and output the data frames included in the preview files.

As previously mentioned, there is no tool or interface for selection of desired preview frames only in present multimedia playback system. Hence, the output result cannot be acquired after sending the preview information. Moreover, individual data frames included in a source file have different characteristics. Ignoring the different characteristics of individual data frames and transferring all the frames as if they were identical is inefficient.

### SUMMARY OF THE INVENTION

Accordingly, an object of the invention is to provide an apparatus and method of producing preview files for application in multiple systems. The invention provides a user interface for selection of only the desired frames. The multimedia playback system considers frame grades, input through the user interface, and the characteristics of the data frames to produce preview files. Additionally, the invention provides an evaluating procedure to display the preview result to a user, resolving the problems presented by the conventional multimedia playback system.

To achieve the foregoing and other objects, the invention discloses an apparatus of producing preview files for previewing data frames. The invention includes a playback engine, a rendering engine, and a drawing engine. The playback engine evaluates source frame data to obtain source frame grades, receives preview grade information, and sends a preview requirement according to the preview grade information. The rendering engine receives the preview requirement, obtains frame data from files according to the preview requirement and the source frame grades, and transfers the frame data into preview files. The drawing engine receives the preview files, and outputs the frames of the preview files.

### BRIEF DESCRIPTION OF THE DRAWINGS

The present invention can be more fully understood by reading the following detailed description and examples with references made to the accompanying drawings, wherein:

FIG. 1 is a diagram of an apparatus of producing preview files for previewing data frames.

FIG. 2 is a flowchart of a method of producing preview files for previewing data frames.

FIG. 3 is a diagram of frame characteristics according to one embodiment.

FIG. 4 is a diagram of user interface according to the embodiment.

### DETAILED DESCRIPTION OF THE INVENTION

As summarized above, the present invention discloses an apparatus of producing preview files for previewing data frames. The inventive apparatus includes a playback engine, a rendering engine, and a drawing engine.

The playback engine evaluates source frame data to obtain source frame grades, receives preview grade information, and sends a preview requirement according to the preview grade information. The playback engine further includes a user interface. The user interface enables input of preview grade information or other information. The preview grade information represents preview grades. The preview grades can be numbers, text, graphics, or any user recognized data type. The source frame data includes video and audio data. The playback engine evaluates the source frame grades according to the characteristics of the source frame data.

The rendering engine is coupled to the playback engine. The rendering engine receives the preview requirement, obtains frame data according to the preview requirement and the source frame grades, and transfers the obtained frame data into preview files. As an example, if source frame grades are classified into five grades and the input preview grade information is grade three, the rendering engine will then transfer the data frames into preview files under grade three.

The drawing engine, coupled to the playback engine, receives the preview files, and outputs the preview frames of the preview files. The data frames in the preview files include video and audio frames.

Moreover, the invention provides a method of producing preview files for previewing data frames. The inventive method first provides a playback engine, a rendering engine, and a drawing engine. The rendering engine and the drawing engine are coupled to the playback engine.

Next, the playback engine evaluates source frame data to obtain source frame grades. The source frame data includes video and audio data. The playback engine obtains the source frame grades according to the characteristics of the source frame data. The playback engine then receives preview grade information, and sends a preview requirement according to the preview grade information. The playback engine further comprises a user interface. The user interface is used to input the preview frame grade information.

Afterwards, the rendering engine receives the preview requirement, and obtains frame data from files according to the preview requirement and the source frame grades. The rendering engine then transfers the frame data into a preview file.

Finally, the drawing engine receives the preview files, and outputs the preview frames of the preview files. The preview frames of the preview files include video and audio frames.

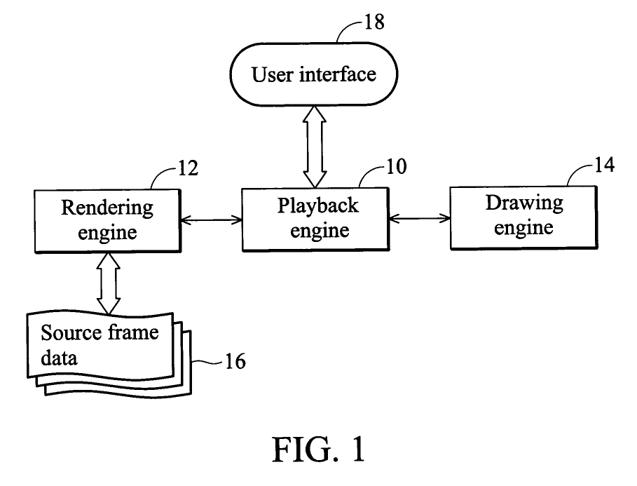

FIG. 1 is a diagram of an apparatus of producing preview files for previewing data frames. An apparatus of producing preview files for previewing data frames is disclosed. In one embodiment, the disclosed apparatus comprises a playback engine 10, a rendering engine 12, and a drawing engine 14.

The playback engine 10 evaluates source frame data to obtain source frame grades. The source frame data includes video and audio data. The source frame grades refer to the characteristics of source frame data. Each frame may have different characteristics. The playback engine also receives preview grade information, and sends a preview requirement according to the preview grade information. The playback engine 10 further includes a user interface 18. The user interface 18 enables input of preview frame grade information. The preview grade information represents the preview frame grades. The preview frame grades can be numbers, text, graphics, or any other user recognized data type. If, for example the preview frame grades are represented as colors, different colors will be shown in the user interface 18 for input as preview frame grade information.

The rendering engine 12 is coupled to the playback engine 10. The rendering engine 12 receives the preview requirement, obtains frame data from files according to the preview requirement and the source frame grades, and transfers the obtained frame data into preview files. If, for example, source frame grades are classified into five grades and grade three is input as the preview grade information, the rendering engine 12 will then transfer the data frames into preview files under grade three.

The drawing engine 14, coupled to the playback engine 10, receives the preview files, and outputs the preview frames of the preview files. The data frames of the preview files include video and audio frames. The drawing engine 14, for example, can connect to a display device and output the data frames of the preview files in the display device.

Thus, the invention discloses an apparatus and method of producing preview files for previewing data frames. The invention can be applied to different multimedia playback systems without regard to the hardware equipment of the multimedia playback system, achieving the goal of application to multiple systems.

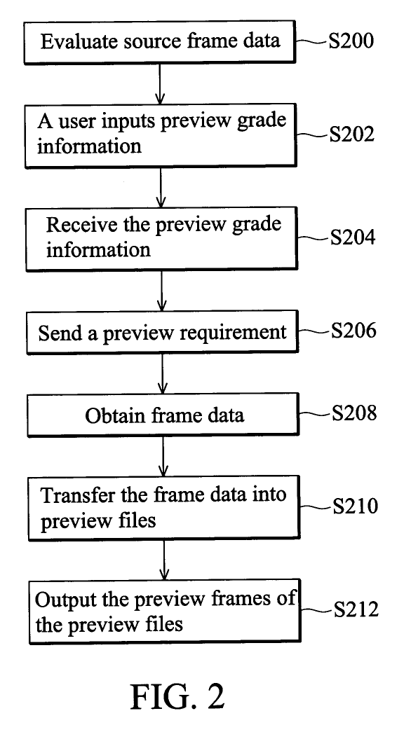

FIG. 2 is a flowchart of a method of producing preview files for previewing data frames. The inventive method first provides a playback engine, a rendering engine, and a drawing engine. The rendering engine and the drawing engine are coupled to the playback engine.

The playback engine evaluates source frame data to obtain source frame grades (step S200). The source frame data comprises video and audio data. The playback engine obtains the source frame grades according to the characteristics of the source frame data.

Next, a user inputs preview grade information through a user interface (step S202). The playback engine then receives the preview grade information (step S204), and sends a preview requirement according to the preview grade information (step S206). The user interface is included in the playback engine for input of preview grade information or other information. The preview grade information is represented as selectable preview grades. If the preview grades are represented as colors, different colors are shown in the user interface. Similarly, if the preview grades are represented as numbers, different numbers are shown in the user interface for selection.

Subsequently, the rendering engine receives the preview requirement and obtains frame data from files according to the preview requirement and the source frame grades (step S208). The rendering engine transfers the frame data into preview files (step s210).

Finally, the drawing engine receives the preview files, and outputs the preview frames of the preview files (step S212). The preview frames of the preview files include video and audio frames. The drawing engine can connect an external display device to display the preview files.

In a general multimedia playback system, a rendering engine receives a frame requirement from a playback engine and obtains the corresponding data frames from files. Comparatively, in the inventive method, the frame requirement received by the rendering engine is a preview requirement from the playback engine. The rendering engine then transfers source frame data into preview files according to the preview requirement. In other words, the disclosed method produces preview files according to user requirements, instead of displaying all the frame data. Thus, the inventive method is more effective and practical.

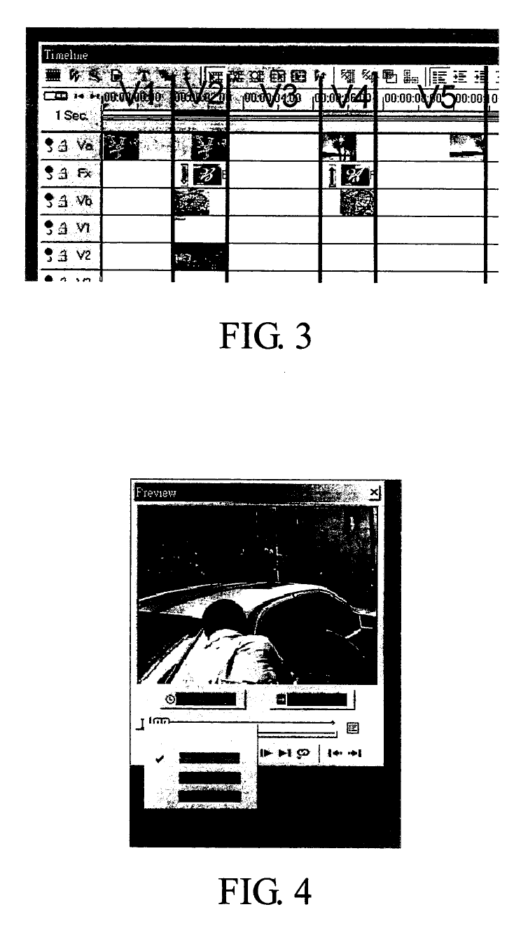

FIG. 3 is a diagram of frame characteristics according to one embodiment. FIG. 4 is a diagram of user interface according to the embodiment. According to the inventive method, a playback engine, a rendering engine, and a drawing engine are provided at first. The rendering engine and the drawing engine are coupled to the playback engine.

The playback engine evaluates source frame data to obtain source frame grades. The source frame data comprises video and audio data. The source frame grades are obtained according to the characteristics of the source frame data, as shown in FIG. 3. The playback engine then receives preview grade information from a user, and sends a preview requirement according to the preview grade information. The playback engine further comprises a user interface. The user interface is a tool for input of preview frame grade information. The preview frame grade information represents preview grades. The preview grades can be numbers, text, graphics, or any other user recognized data type. If the preview grades are represented as colors, different colors are shown in the user interface for selection.

Next, the rendering engine receives the preview requirement and the source frame grades as shown in FIG. 3 and obtains frame data. The rendering engine transfers the frame data into preview files.

Finally, the drawing engine receives the preview files, and outputs the preview frames of the preview files as shown in FIG. 4. The preview frames of the preview files include video and audio frames

Thus, an apparatus and method of producing preview files for previewing data frames is provided. The invention utilizes a user interface for selection. The invention considers the characteristics of the source frames and the user selection to produce preview files. Furthermore, the invention only shows preview results that have been evaluated. Additionally, the invention can be applied to different systems and hardware, achieving the main goal of the invention.

It will be appreciated from the foregoing description that the apparatus and method described herein provide an effective solution to the multimedia data preview problem. If, for example, the evaluation method is altered, the apparatus and method of the present invention can be revised accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus of producing preview files for previewing data frames, comprising:
a playback engine, evaluating source frame data to obtain a plurality of source frame grades, receiving preview grade information, and sending a preview requirement according to the preview grade information;
a rendering engine, coupled to the playback engine, receiving the preview requirement, obtaining at least one frame data from files according to the preview requirement and the source frame grades, and transferring data from at least one frame into at least one preview file; and
a drawing engine, coupled to the playback engine, receiving the at least one preview file, and outputting preview frames of the at least one preview file.

2. The apparatus as claimed in claim 1, wherein the source frame grades are evaluated according to the characteristics of the source frame data.

3. The apparatus as claimed in claim 1, wherein the playback engine further comprises a user interface for input of preview frame grade information.

4. The apparatus as claimed in claim 1, wherein the source frame data comprises video and audio data.

5. The apparatus as claimed in claim 1, wherein the preview frames of at least one preview file comprise video and audio frames.

6. A method of producing preview files for previewing data frames, comprising the steps of:
providing a playback engine, a rendering engine, and a drawing engine, wherein the rendering engine and the drawing engine are coupled to the playback engine;
the playback engine evaluating source frame data to obtain a plurality of source frame grades;
the playback engine receiving preview grade information and sending a preview requirement according to the preview grade information;
the rendering engine receiving the preview requirement, and obtaining at least one frame data from files according to the preview requirement and the source frame grades;
the rendering engine transferring the at least one frame data into at least one preview file; and
the drawing engine receiving the at least one preview file, and outputting preview frames of the at least one preview file.

7. The method as claimed in claim 6, wherein the source frame grades are evaluated according to the characteristics of the source frame data.

8. The method as claimed in claim 6, wherein the playback engine further comprises a user interface for inputting the preview frame grade information.

9. The method as claimed in claim 6, wherein the source frame data comprises video and audio data.

10. The method as claimed in claim 6, wherein the preview frames of the at least one preview file comprise video and audio frames.
